(19) United States
(12) Patent Application Publication
(10) Pub. No.: US 2011/0113843 A1
(43) Pub. Date: May 19, 2011

(54) PROCESS FOR PRODUCING AN ORGANO-MINERAL FERTILIZER

(75) Inventors: Paulo Eduardo Mantelatto, Piracicaba (BR); Fernando Cesar Boscariol, Piracicaba (BR); Marcilio Nogueira do Amaral Gurgel, Campinas (BR); Antonio Rogerio Pereira Cesar, Piracicaba (BR); Joao Rafael Perroni Ciambelli, Serra Negra (BR)

(73) Assignee: DEDINI S.A. INDUSTRIAS DE BASE, Piracicaba - SP (BR)

(21) Appl. No.: 12/988,900

(22) PCT Filed: Apr. 20, 2009
(86) PCT No.: PCT/BR2009/000109

§ 371 Date: Jan. 25, 2011

(30) Foreign Application Priority Data
Apr. 23, 2008 (BR) PI0801794-8

(51) Int. Cl. C05F 11/00

(52) U.S. Cl. 71/23

(57) ABSTRACT

The invention relates to a process for producing an organo-mineral fertilizer from vinasse, filter cake and generally boiler ashes, as byproducts of the sugar and/or alcohol manufacture and, optionally, complemented with fertilizer sources composed of macronutrients (primary and secondary) and micronutrients. The process comprises, in a preferred form of the invention, the steps of: concentrating the vinasse until about 65% of solids (p/p); mixing and dissolving the fertilizer elements in the concentrated vinasse; mixing and drying the filter cake and ashes in a hot gas stream obtained by burning bagasse or fine straw; impregnating this dry mixture with the concentrated vinasse mixture and the added fertilizer agents; and, finally, drying and granulating the final formulated mixture. The end product is a granular solid containing N, P, K, Ca, S, Mg and micronutrients, according to the previously programmed formulation. In the other form of the invention, the same process is effected, but without adding the fertilizer elements.

### FIELD OF THE INVENTION

The present invention refers to a process for the use of byproducts from the sugar and alcohol manufacture, for production of an organo-mineral fertilizer.

### BACKGROUND OF THE INVENTION

The prior art comprises a productive process in which the raw material used for obtaining the organo-mineral fertilizer granules (OMF) comprises byproducts from the sugar and alcohol manufacture, which are rich in mineral and organic material and defined by: vinasse, cake, boiler ashes, and which are mixed to: primary macronutrients, as nitrogen (N), phosphorus (P) and potassium (K); secondary macronutrients, such as calcium (Ca) magnesium (Mg) and sulphur (S); micronutrients, such as boron (B), chlorine (Cl), copper (Cu), iron (Fe), manganese (Mn), molybdenum (Mo), zinc (Zn) and cobalt (Co).

The definition of the organo-mineral fertilizer is well characterized in KIEHL (KIEHL, E. J., Organic Fertilizers, p. 134-135—Editora CERES Ltda., Sao Paulo-Brazil, 1985). According to the author, it is considered organic fertilizer every product from vegetable or animal origin which, when applied to the soil in adequate amounts, seasons and manners, promotes improvements of the physical, chemical, physical-chemical and biological attributes of the soil, effecting corrections of unfavorable chemical reactions or excess of toxicity and providing nutrients to the roots in a sufficient amount to produce profitable crops with good quality, without causing damage to the soil, plantation or environment. In Brazil, in accordance with Decree 86,955 of Feb. 18, 1982, organic fertilizers are products from vegetable or animal origin, classified as follow:

SIMPLE ORGANIC FERTILIZERS—fertilizers from vegetable or animal origin, containing one or more plant nutrients.
ORGANO-MINERAL FERTILIZERS—fertilizers resulting from the mixture or combination of organic and mineral fertilizers.
COMPOUND FERTILIZERS—fertilizers obtained by natural or controlled biochemical process, with mixture of vegetable or animal residues.

In order to better understand the generation of the main components of the organo-mineral fertilizer (OMF) in the sugar and alcohol industry complex, the main steps of the sugar and alcohol manufacturing process will be described below.

The conventional process for producing sugar, alcohol and byproducts (filter cake, boiler ashes, vinasse and carbonic gas and combustion gases) comprises the following steps. The manually or mechanically harvested cane in the plantation is sent to the industry, where it is cleaned (via dry or wet process), then submitted to a preparation process in which it is chopped and defibered, submitted to extraction, which can be effected in multi-stage (usually 4 to 6) countercurrent mills, where the cane receives the addition of water in the last stage, or in diffusors, not very common in Brazil. This initial process generates the bagasse, which is sent to be burned in boilers (of medium or high pressure) to generate steam and electric energy. The material resulting from the bagasse burning is defined by the ash and the combustion gas. The extracted mixed juice is sent to a physical-chemical treatment to produce sugar and/or alcohol, depending whether the mill is a combined mill (producing sugar and alcohol) or an autonomous distillery (producing solely alcohol).

In the combined mills, generally about 50% of the processed cane is destined to sugar manufacture and 50% to the production of alcohol.

The juice destined to the production of alcohol undergoes specific physical-chemical treatment and is sent to the fermentation vessels, jointly with the exhausted final run-off syrup (mother liquor) resulting from the production of sugar.

This mixture, known as must, undergoes an alcoholic fermentation process, in agitated tanks (vessels) using yeasts (Saccharomyces cerevisiae), which generates a fermented must containing from 6 to 11% of ethanol. As a byproduct of the fermentation process, it is further generated carbonic gas, in a mass amount of 1:1 in relation to the ethanol, and fusel oil (less than 1% by mass) which is separated in a posterior distillation step. The resulting fermented must is then submitted to centrifugation, where the yeast is separated and recycled, and the wine containing ethanol is conveyed to distillation. Subsequently, the wine is usually brought into direct contact with the steam in distillation columns, generating two streams, an ethanol stream at the top and a vinasse stream at the bottom. Due to the utilization of vapor in direct contact with the wine, there occurs the incorporation of condensate in the vinasse, and the volume generated can be of about 10-14 times the volume of the alcohol, depending on the wine alcoholic degree. There also exists the distillation process by indirect contact, generating a smaller vinasse volume, of about 6 to 8 times the alcohol volume.

The mixed juice destined to sugar manufacture is submitted to an operation of separating the bagacillo in cush-cush type screen (and/or rotary screens), is heated to about 40° C. and conveyed to the sulfitation step (usually in columns or hydro-ejectors) where, by addition of sulphur dioxide resulting from sulphur burning in the burners, has its pH reduced to about 4.0-4.5.

After sulfitation, the juice receives the addition of lime milk (or calcium saccharate), where the pH is elevated to about 7.0-7.2.

The limed (or dosed) juice is then heated to about 105° C., and subsequently undergoes a vaporization process (“flash balloon”) for removing dissolved gases, receives the addition of a flocculating agent (usually a polyacrylamide polyelectrolyte) and is then submitted to decantation in static decanters (with or without trays). This operation is also commonly known as clarification. Two streams result from the clarification process: a sludge stream and a clarified juice stream. The sludge, after being added with bagacillo (a type of “natural filtrating means”), receives the addition of lime milk and, eventually, polyelectrolyte, and is then filtrated in vacuum rotary filters or belt press filters”, thus giving rise to the filter cake, which is used in agriculture, as well as the filtrated juice, which is re-conducted to the process.

The obtained clarified juice is sent to evaporation in multiple effect vacuum evaporators (usually Robert type evaporators with 4 or 5 stages), yielding a concentrate juice known as syrup, with a concentration of about 65° Brix.

In the first evaporation stage, normally denominated pre-evaporation, a vapor bleeding (V1) is effected to utilize said vapor in the operations of evaporation-crystallization, of heating the mixed juice and of distillation in the production of alcohol.

The syrup obtained in the evaporation is conveyed to the posterior crystallization step, which is carried out in vacuum calendar type evaporating crystallizers in systems with two or three masses.

Generally, the conventional crystallization process takes from 3 to 5 hours, and the crystal mass thus obtained is conveyed to horizontal crystallizers provided with a cooling jacket until reaching the ambient temperature.

The final mass is then submitted to a centrifugation cycle, in basket centrifuges, in which the crystals are washed upon application of water and steam and then conducted to the drying and bagging steps.

The run-off syrup obtained in the centrifugation is re-used in the cooking operations for obtaining the second sugar (sugar B or magma) and, eventually, the third sugar (sugar C or magma), which are also re-circulated in the first sugar manufacturing process. The end syrup (molasse) originated in mass B in systems with two masses, or originated in mass C, is conveyed to alcohol manufacture, jointly with part of the juice separated for the production of alcohol.

For production of the organo-mineral fertilizer, besides the byproducts of sugar and alcohol industry complex, there can be used, as source of primary and secondary macronutrients and micronutrients, commercial compounds as described below.

As a nitrogen source, it can be used at least one of the compounds selected from anhydrous ammonia, aqueous ammonia, ammonium nitrate, calcium ammonium nitrate (calcium nitrate), ammonium sulphate, ammonium sulphate nitrate, calcium cyanamide, sodium nitrate, urea, urea formaldehyde;

As a phosphorus source, it can be used at least one of the compounds selected from basic slags, bone flour, phosphoric acid, phosphate rock, phosphatic concentrates, single super phosphate, triple super phosphate, super phosphoric acid;

As a potassium source, it can be used at least one of the compounds selected from potassium chloride (muriate), potassium carbonate, double potassium-magnesium sulphate, potassium sulphate;

As a source of mixture of nitrogen, phosphorus, potassium, calcium, magnesium, sulphur and other micronutrients, it can be used at least one of the compounds selected from ammoniated super phosphate, ammonium nitro-phosphate, ammonium sulphonitrate, cottonseed hull ashes, diammonium phosphate, monoammonium phosphate, nitro-phosphate, potassium and sodium nitrate, wood ashes, basic high-furnace slags, dolomite, plaster, kieserite, lime, sulphocalcic solution, magnesium sulphate (Epson salts) and sulphur.

As a source of calcium, it can be used at least one of the compounds selected from high-furnace slags, calcitic lime, dolomitic lime, plaster, calcium oxide (quicklime), calcium hydroxide (hydrated lime), calcium sulphate (phosphoplaster), marble, calcium cyanamide, calcium nitrate, phosphatic rock, single super phosphate and triple super phosphate.

As a source of magnesium, it can be used at least one of the compounds selected from dolomitic lime, magnesium sulphate (bitter salt), calcined kieserite, magnesia, double potassium-magnesium sulphate.

As a source of sulphur, it can be used at least one of the compounds selected from ammonium sulphate, iron sulphate, copper sulphate, magnesium sulphate (bitter salt), phosphoplaster, manganese sulphate, single super phosphate, double potassium-magnesium sulphate, elementary sulphur, sulphur dioxide, triple super phosphate and zinc sulphate.

As a source of boron, it can be used at least one of the compounds selected from boron frits, borax, boric acid, sodium pentaborate, sodium tetraborate and Solubor.

As a source of copper, it can be used at least one of the compounds selected from basic copper sulphate, copper ammonium phosphate, copper chelates (Na₂Cu HEDTA), copper chloride, copper frits, REAX Copper, TDHIS copper, Silviplex Copper, copper sulphate monohydrate, copper sulphate pentahydrate, copper oxide, cuprous oxide and Rayplex copper.

As a source of iron, it can be used at least one of the compounds selected from iron ammonium phosphate, iron ammonium polyphosphate, iron frits, ferric sulphate, ferrous sulphate, iron chelates (NaFeEDTA or FeHEDTA), Reax iron, TDHIS iron, Silviplex iron and Rayplex iron.

As a source of manganese, it can be used at least one of the compounds selected from manganese chelates (MnEDTA), Reax manganese (MnMPP), TDHIS manganese (MnPP), Silviplex manganese (MnMPPP), manganese sulphate, manganese frits, manganese oxide and Rayplex manganese (MnPF).

As a source of molybdenum, it can be used at least one of the compounds selected from sodium molybdate, molybdenum trioxide and ammonium molybdate.

As a source of zinc, it can be used at least one of the compounds selected from zinc carbonate, zinc chelates (Na₂ZnEDTA or NaZnHEDTA), zinc oxide, Reax zinc (ZnMPP), TDHIS zinc (ZnPP), Silviplex zinc (ZnMPPP), zinc sulphate and Rayplex zinc (ZnPF).

### Benefits of the Organic Matter on the Properties and Productivity of the Soil

KIEHL (KIEHL, E. J., Organic Fertilizers, p 27-84, Editora CERES Ltda., 1985) relates the soil productivity to the sum of three basic factors: climate, physical properties and chemical or fertility properties of the soil. The climate is considered the most important factor and the most difficult to be controlled; the physical and chemical conditions are respectively considered secondary and tertiary factors, since they are easier to control. Therefore, apart from the climate factor, the other factors can be significantly altered by action of the organic matter in the soil properties, said organic matter being the main component of the OMF.

The organic matter applied on the soil has positive effects on the soil properties, such as:

Physical properties: apparent density, structuration, aeration and drainage, water retention, consistency.
Chemical properties: nutrient supply (primary and secondary macro and micronutrients), correction of toxic substances, pH index and buffering capacity.
Physical-chemical properties: nutrient adsorption, ionic change capacity, specific surface.
Biological properties: they favor the development of microorganisms responsible for the degradation of organic matter (bacteria, fungi, actinomycetes and algae).

These byproducts obtained according to the previous description have a high potential as raw material for agro-industrial use, due to the produced volume and to their organic and mineral content (which are rich in N, P and, mainly, K).

In spite of the great potential for an advantageous use in agriculture, the application of these byproducts in the form such as obtained in the sugar and alcohol manufacturing process can represent threats to the environment, instead of economic advantages. For example, whether vinasse provides a fertilizing action or a polluting one will depend on the form, on the application site and on the quantity to be applied.

By analyzing in terms of population equivalent, a distillery producing 120 m³ of ethanol/day from sugar cane molasse has a polluting potential, coming from the organic content, equivalent to 695.000 inhabitants.

Vinasse application in the crop site requires special attention to the content of mineral salts.

Depending on the soil type, the intensive vinasse application can cause a temporary or definitive damage to the soil and even contaminate the ground water. Vinasse storage in lagoons leads to a rapid microbial decomposition with consequent formation of scatological substances, which cause strong unpleasant smell.

For applying these byproducts, some factors should be considered, such as:
The great majority of mills do not have an environmentally adequate vinasse transport and distribution system, and their adaptation would require new investments and technical adaptations. In certain areas, nowadays, there are great risks of ground water contamination;
The greatest alcohol production center in Brazil, sao Paulo, is situated over one of the greatest underground water reserves of the country, Bauru and Guarani aquifers. In the region called recharge area, in the state of sao Paulo, both aquifers are greatly exposed, very close to the soil surface;
Many mills are located close to springs and permanent preservation areas;
The vinasse volume, maintaining the current rates, will double in the next ten years;
Transporting large volumes of vinasse as obtained in the process, for distances greater than 25 km from the production center, raises significantly the transport and distribution costs;
Most transport and distribution systems use, petroleum-based non-renewable energy sources;
There is a limit for applying vinasse on the soil, beyond which its properties are unfavorably altered, leading to the soil salinization and ground water contamination, and to the need of constantly changing areas. In states such as sao Paulo, there are predetermined limits of vinasse to be applied, depending on the region, soil type and vinasse composition in terms of potassium (CETESB-Environmental Sanitation Technology Company of State of Sao Paulo-Rule P4.231).

In order to have an idea of the production volumes involved in sugar and alcohol industry in Brazil, according to DATAGRO (a private sugarcane consulting group in Brazil), in the 2006/2007 harvests, there were processed, in 325 units in operation, 426,613,891 tons of sugar cane cultivated in an area of 5,340,000 hectares (8.8% of the agriculturable area in Brazil), producing 17,850,646 m³ of bioethanol and 30,606,677 tons of sugar. With respect to the alcohol production, it can be foreseen, for the main byproduct—the vinasse, an associated production volume of 10 to 14 times the bioethanol production, which permits estimating a volume of about 180 to 200 millions of m³/year.

In the case of cake and ashes, the volumes generated are smaller, 1.5 to 4.0 kg/ton of sugar cane and 35-40 kg/ton of sugar cane, respectively.

Tables 1, 2 and 3, presented below, indicate the usual basic compositions of the vinasse, filter cake and ashes. Table 1 indicates the basic composition of the filter cakes produced in combined sugar cane mills, i.e., mills that produce both sugar and ethanol.

TABLE 1
Filter Cake
Chemical Composition of the Filter Cake

| Element | Dry matter |
|---|---|
| N | 0.87 |
| P₂O₅ | 1.35 |
| K₂O | 0.28 |
| CaO | 2.18 |
| MgO | 0.24 |
| SO₄ | |
| SiO₂ | 14.06 |
| Carbon | 31.2 |

ppm Dry matter

| | |
|---|---|
| Fe | 34.87 |
| Mn | 590 |
| Cu | 51 |
| Zn | 83 |
| Mo | |
| Moisture | 74.77 |

Source: IAA/PLANALSUCAR

Table 2 indicates the basic composition of boiler ashes resulting from sugar cane bagasse burning.

TABLE 2
Sugar Cane Bagasse Ashes
Composition of the boiler ashes

| Element | % |
|---|---|
| P₂O₅ | 0.87 |
| K₂O | 1.67 |
| CaO | 0.99 |
| MgO | 0.56 |
| Fe₂O₃ | |
| Al₂O₃ | |
| AL₂O₃ + FeO₅ | 8.05 |
| MnO | |
| SiO₂ | 85.22 |

Source: IAA/PLANALSUCAR
OBS.: About 2.5% of the total burned bagasse is transformed in ashes

Table 3 indicates the basic composition of vinasse resulting from fermentation of musts prepared with the sugar cane juice, juice and molasse mixture, and molasse, and submitted to distillation.

TABLE 3
Usual Chemical Composition of the Vinasse

| | Must Vinasse (Kg/m3) | | |
|---|---|---|---|
| | | of juice | |
| | of | and molasse | of |
| Elements | molasse | mixture | juice |
| N | 0.77 | 0.46 | 0.28 |
| P₂O₅ | 0.19 | 0.24 | 0.20 |
| K₂O | 6.00 | 3.06 | 1.47 |
| CaO | 2.45 | 1.18 | 0.46 |
| MgO | 1.04 | 0.53 | 0.29 |
| SO₄ | 3.73 | 2.67 | 1.32 |
| MO | 52.04 | 32.63 | 23.44 |

ppm

| | | | |
|---|---|---|---|
| Fe | 80.00 | 78.00 | 69.00 |
| Cu | 5.00 | 21.00 | 7.00 |
| Zn | 3.00 | 19.00 | 2.00 |
| Mn | 8.00 | 6.00 | 7.00 |
| pH | 4.40 | 4.10 | 3.70 |

Source: Gloria and Orlando Filho, 1984

In relation to the application of these byproducts in agriculture, the cake in the sugar cane crop site is applied in the form it is obtained in the process or as a stabilized product after passing through a composting process. The vinasse, in most mills, is applied directly to the sugar cane crop site, in the form as obtained in the process. There are several ways of applying vinasse to the plantations: application directly to the grooves by trucks, either by spraying with hoses associated with tank trucks, or by spraying through a pumping system directly from channels distributed across the plantations. Despite the solution adopted so far is, in a certain way, economically available for distances of about 25 km between the vinasse production and its application, the following aspects should be considered.

A rational process for using these byproducts should take into account a technology which provides a better application thereof in plantation regarding the environmental aspect, and which enhances the profitability in the agroindustrial complexes where they are produced. Although simple and direct solutions are not available, it should be emphasized that it is not technologically impossible to make these byproducts in commercializable products. However, the involved economic-financial aspects require a careful analysis, since the bioethanol production is fundamentally intended to substitute gasoline or, more precisely, the petroleum-based non-renewable energy sources. Thus, it is necessary that the byproduct processing cost does not unfavorably alter the bioethanol competitiveness as a fuel. On the other hand, the industrial processing of these byproducts, by requiring an intensive use of energy, will compete directly with the electric energy cogeneration process, thereby creating a problem of complex solution.

Moreover, the vinasse has been characterized as residue until recently. Studies proposed since the 80's point out individual or combined alternatives, such as: use of concentrated vinasse directly as fertilizers or incineration of vinasse in boiler and posterior use of the ashes as fertilizers; concentration and drying of vinasse by atomization and subsequent use as animal food; anaerobic fermentation of vinasse for producing methanol to be used for burning in boilers or as an automobile fuel; aerobic fermentation of vinasse, fractional crystallization of vinasse salts, composting of concentrated vinasse with filter cake and with algae culture, among others. Most existing studies are from the 70's-80's and are out-of-date in relation to the current scenario, in which the petroleum barrel price is around US$100. The agroindustrial complex currently contemplates the soy and biodiesel production, the electrical energy cogeneration from bagasse and straw, the maximum use/recovery of the water introduced with the sugar cane (about 700 kg/ton of sugar cane), production of bioethanol by using new technologies for maximizing the alcoholic concentration in fermentation and the minimum use of water introduced in distillation, in order to minimize the vinasse volume generated in the process, maximize the energy recovery in the sugar and alcohol manufacture, and minimize the generation of effluents and maximize the use of byproducts.

In order to achieve the objects described above, the proposed process intends to develop a technology for providing a perfect energetic integration in the agroindustrial complex, and a return on investment compatible with the investors' expectations, enabling to increase the profitability, as well as complying with the business self-sustainability requirements. Such objects require a critical analysis of the whole productive chain, especially the unitary operations of the industrial complex.

### SUMMARY OF THE INVENTION

As a function of the prior art limitations, the present invention has, as an objective, to provide a process for producing a granular solid organo-mineral fertilizer, rich in organic matter and, preferably N, P, K, Ca, Mg, S and micronutrients, to be applied in agriculture in the same way as the conventional fertilizer, therefore, dispensing specific machines for cake and ash distribution, as well as machines and pumps for vinasse application, and which also allows great reduction of the material volume to be transported, drastic reduction of the risk of ground water contamination and environmental deterioration.

The present process also aims obtaining a fertilizer which leads to extra benefits for the crop productivity, increasing the profitability of the agroindustrial complex.

The process for producing an organo-mineral fertilizer (OMF), comprising the byproducts vinasse and filter cake resulting from the sugar and alcohol manufacture from sugar cane, object of this invention, comprises the steps of: (i) submitting the vinasse, resulting from the alcohol manufacturing process, to a concentration by evaporation of part of the water contained therein; (ii) submitting the filter cake, obtained in the sugar and/or alcohol manufacturing process, to an operation for removing part of the water contained therein, via mechanical and via drying processes; (iii) impregnating the filter cake obtained in step (ii) with the concentrated vinasse, in mechanical mixers; and (iv) drying and granulating the mixture obtained in step (iii), removing part of the water contained therein.

The end product is a granule similar to a granulated mineral fertilizer. The energy used in the process is the energy recovered from the production process, as a consequence of the study for a better use of the energy available in the sugar and alcohol production process. The distribution of the product is made in a conventional way, as in the conventional fertilizer distribution.

Thus, unlike the current systems, the need for investment in especial machines to distribute and manipulate cake, machines for application and distribution of vinasse and machines for distribution of conventional fertilizer is prevented. This results in less fossil fuel consumption, less investment in machines and equipment for transport and pumping, less soil compactation and less operational cost.

The fertilizer of the present invention provides a general improvement in the soil properties (KIEHL, E. J., Organic Fertilizers, pages 26-82, Editora CERES Ltda., 1985), with consequent raise of the sugar cane crop productivity, when compared with conventional manuring (KIEHL, E. J., Organic Fertilizers, pages 101-102, Editora CERES Ltda., 1985) since, when in contact with the soil, it promotes a controlled release of nutrients and a full use of the mineral and organic material (GLORIA, N. A. and MATTIAZZO, M. E.—“Effect of organic matter on solubilization of soil phosphates” and “Effect of residues from sugar mills and distilleries (sugar cane bagasse, filter cake and vinasse)”, Brasil Agucareiro, 88(5): 386-395,1976), minimizing the processes of leaching and phosphorus immobilization by R₂O₃ (Al₂O₃ and Fe₂O₃), with an increase of the soil pH (EIRA, A. F. and CARVALHO, P. C. T.—“Decomposition of organic matter by soil microorganisms and their influence in pH variation”, Revista da Agricultura, Brazil, 45:15-21, 1970), eliminating the risk of ground water contamination, improving the cationic exchange capacity (CEC) of the soil, preventing the release of bad odor, improving the water retention capacity and the soil granulation capacity, reducing the compactation and erosion, favoring the beneficial microorganism development (fungi and bacteria), actuating in several processes, as the mineralization and immobilization of N, and its nitrification, denitrification and biological fixation (ALMEIDA, F. F. Interference of fungi in manuring by vinasse, Piracicaba, ESALQ-USP,1954, Brazil, 44P, Gazette of the Instituto Zimotécnico, 5) and, finally, raising the productivity of the sugar cane biomass/kg applied fertilizer. Yet as byproduct of this process, condensate (water) is produced which, after a relatively simple treatment, can be used in the agroindustrial complex or even exported to other systems or used for other purposes.

### BRIEF DESCRIPTION OF THE DRAWINGS

The invention will be described below, with reference to the enclosed drawings, given by way of example of a possible way of carrying out the invention and in which:

FIG. 1 represents the flowchart of the process for producing an organo-mineral fertilizer from filter cake, boiler ashes, vinasse, byproducts of the sugar and alcohol manufacture, complemented with fertilizer sources, composed of macronutrients (primary and secondary) and micronutrients.

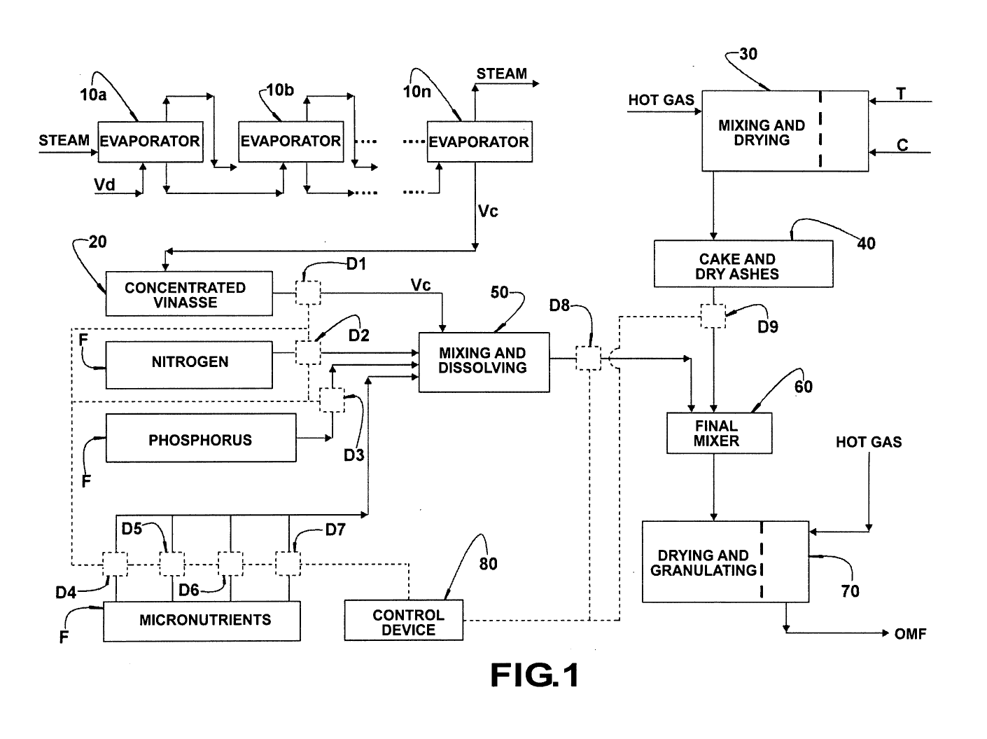

### DESCRIPTION OF THE INVENTION

In the described process, the diluted vinasse Vd, originating from the alcohol manufacturing process, is concentrated in evaporators 10a, 10b . . . 10n, with a concentration of 20 to 65% (p/p) of solids, preferably 65%, and conducted, as a concentrated vinasse Vc, to a storage tank 20 for posterior use.

The cake T originating from the filters is dehydrated/dried until a moisture between 2% and 70% (p/p), more preferably between 2% and 30% and, more preferably between 10% and 20% (p/p).

The cake T and the ash C coming from the boilers are mixed, the mixture formed by the filter cake and boiler ashes being dehydrated/dried until a moisture between 5% and 70% (p/p), more preferably between 5% and 20%, even more preferably between 10% and 12% (p/p), in an equipment 30 for removing water and drying, and conveyed to the storage in a silo 40.

The concentrated vinasse Vc is added with fertilizer elements, for example from sources of N, P, Ca, S, Mg and other micronutrients which are mixed in a mixing equipment 50. This mixture (suspension) is then dosed and mixed, in a final mixer 60, with the cake and, generally, with ashes previously dried and stored in the silo 40, the mixture being then conducted to the final drying and granulation step in the equipment 70. The end product is a granular solid, generally containing N, P, K, Ca, S, Mg and other micronutrients, according to a previously programmed formulation. The dosage control of the fertilizer elements (primary and secondary macronutrients plus the micronutrients) is performed by an electronic dosage control device 80, operatively associated with the dosage means D1, D2, D3, D4 . . . Dn, and which contains, stored in its database, information regarding the stored compounds and the programmed formulation.

It should be understood that the sources consisting of primary and second macronutrients and micronutrients, such as nitrogen, phosphorus, potassium, calcium, magnesium, sulphur, boron, copper, iron, manganese, molybdenum and zinc can be those defined in the introduction of the present specification, not being necessary to repeat them in the description of the invention.

In a first way of carrying out the invention, the process for producing an organo-mineral fertilizer using the byproducts of the sugar and alcohol manufacture, comprises the following possible combinations: filter cake T and concentrated vinasse Vc, (filter cake+boiler ashes) and concentrated vinasse Vc and the gas originating from the bagasse and/or fine straw burning, and/or gas effluent from the boiler chimney for drying. The process comprises the steps of: submitting the diluted vinasse Vd, produced in the alcohol manufacturing processes, to concentration, by evaporation in the serial evaporators 10a, 10b . . . 10n, preferably in cascade under vacuum, as for example, falling-film or turbulent mist evaporators, using vapor as a heating source, until reaching a concentration of 20 to 65% (p/p) of solids, preferably 65%. The steam used in a first vinasse evaporative effect can be an exhausted steam or a vegetal vapor originating from a pre-evaporator, or second and third evaporative effects applied to the sugar cane juice. The first vinasse evaporative effect can be effected with the use of gases effluent from the drying of the cake and vinasse mixture.

Then, by using a mixture is prepared from the filter cake T or filter cake+ashes resulting from the burning of bagasse in the boiler, which mixture is submitted to a previous process for removing water, via mechanical and via drying, in the equipment 30 for removing water and drying. The concentrated vinasse Vc can then receive the addition of fertilizer elements based on primary macronutrients (N, P and K), secondary macronutrients, as calcium (Ca), magnesium (Mg) and sulphur (S), and micronutrients, as zinc (Zn), iron (Fe), copper (Cu), chlorine (Cl), boron (Bo) manganese (Mn) and molybdenum (Mo), so as to obtain the final formulation adequate to the previously programmed agricultural application. Next, after being mechanically mixed in the final mixer 60, to homogenize the material, said mixture is submitted to drying and granulating operations in a hot gas stream until reaching a final moisture for the granular solid product of about 2 to 20%, more preferably of about 10% (p/p).

In the embodiment described above, the drying/mixing of the OMF components is performed in the following sequence: mixing the boiler ashes to the moist cake; dewatering/drying the mixture of cake and ashes; adding the macro- and micronutrients to the concentrated vinasse; mixing the cake and dry ashes with the concentrated vinasse containing the macro- and micronutrients; afterwards, drying the mixture.

The drying of the mixture of cake and boiler ashes and of the final mixture is effected in a single stage or in several stages, with the drying gases flowing in a parallel or cross flow, and preferably, in dryers of the fluidized bed type or vibro-fluidized dryer, or spouted bed dryer, or rotary drum dryer or in turbo dryers.

In another embodiment, the process for producing an organo-mineral fertilizer uses the byproducts of the sugar and alcohol manufacture, comprising the mixture composed by filter cake+vinasse or by filter cake+boiler ashes+vinasse. The process comprises the steps of submitting the diluted vinasse Vd, produced in the alcohol manufacturing processes, to the concentration by evaporation in the evaporators 10a, 10b . . . 10n, preferably in a multiple effect vacuum evaporator, until reaching a concentration of 20 to 65% (p/p) of solids, preferably 65%. Then, it is prepared a mixture from the filter cake T obtained in the sugar and alcohol manufacturing process, or from the filter cake with ashes C resulting from burning the bagasse in the boiler, which mixture is submitted to a previous process for removing water, via mechanical and via drying, in the equipment 30 for removing water and drying. Next, this mixture is submitted to drying and granulation in a hot gas stream until reaching a final moisture of the granular solid product of about 2 to 20%, more preferably, of about 10% (p/p). It should be emphasized that the preferred combination of byproducts is the one which uses cake, ashes and concentrated vinasse. Since the vinasse is originally acid and the ashes have alkaline characteristics, it is possible to obtain a neutralization effect and, thus, an end product with better physical-chemical properties, with less input consumption.

In both ways of carrying out the invention, the previous mechanical dewatering of the mixture composed by cake and ashes can be effected through mechanical devices, as press filter, belt press filter, or other pressing device. In the sequence, the drying of this mixture can be carried out in a drying equipment as, for example, a rotary drum dryer, a fluidized bed dryer, a vibro-fluidized bed dryer, a spouted bed dryer, turbo dryers, introducing a parallel or counter-current hot air current and the gas can be originated from the bagasse and/or fine straw burning, and/or gas effluent from the boiler chimney.

The drying and granulation of the final mixture containing vinasse, cake, ashes, in the second embodiment of the invention, or containing these components plus macronutrients (primary and secondary) and micronutrients, in the first embodiment, can be performed using the same granulation and drying system used for drying the mixture formed by cake and ashes.

The addition of a nitrogen source to the organo-mineral fertilizer can be effected by adding ammonium carbonate obtained from the reaction between the commercial ammonia and carbonic gas originated from the alcoholic fermentation of fermentable sugary compounds, preferably, from sugar cane, beet, corn and sorghum, more preferably, from sugar cane or beet, and more preferably, from sugar cane.

1. A process for producing an organo-mineral fertilizer (OMF), comprising vinasse and filter cake byproducts resulting from the manufacture of sugar and alcohol from sugar cane, which comprises:
i—submitting vinasse, resulting from the alcohol manufacturing process to concentration by evaporation of part of the water contained therein;
ii—removing from a filter cake, obtained in the sugar and/or alcohol manufacturing process, part of the water contained therein, via mechanical and drying processes;
iii—impregnating the filter cake obtained in step (ii) with the concentrated vinasse, in a mechanical mixer;
iv—drying and granulating the mixture obtained in step (iii), and removing part of the water contained therein.

2. The process, as set forth in claim 1, wherein the vinasse is concentrated to between about 10% (p/p) to 65% (p/p) of dry matter.

3. The process, as set forth in claim 1, which comprises dehydrating and drying filter cake to achieve a moisture between 2% and 70% (p/p).

4. The process, as set forth in claim 1, wherein boiler ashes obtained by burning the bagasse and/or sugar cane fine straw is added to the cake obtained in step (ii).

5. The process, as set forth in claim 4, which comprises dehydrating and drying the filter cake and boiler ash mixture until a moisture level between 5% and 70% (p/p), is achieved.

6. The process, as set forth in claim 4, wherein the mixture comprising filter cake, ashes and concentrated vinasse is added, in step (iii), to fertilizer compounds based on primary macronutrients N, P and K, and secondary macronutrients Ca, Mg and S and micronutrients Zn, Fe, Cu, Cl, Bo, Mn, Mo, to obtain a formulation adequate to support a previously programmed agricultural application.

7. The process, as set forth in claim 1, wherein the filter cake and concentrated vinasse are added, in step (iii), with fertilizer compounds based on primary macronutrients and secondary macronutrients and micronutrients, so as to obtain a formulation adequate to the previously programmed agricultural application.

8. The process, as set forth in claim 6, wherein the nitrogen source comprises at least one of the compounds selected from the group consisting of anhydrous ammonia, aqueous ammonia, ammonium nitrate, calcium ammonium nitrate (calcium nitrate), ammonium sulphate, ammonium sulphate nitrate, calcium cyanamide, sodium nitrate, urea and urea formaldehyde.

9. The process, as set forth in claim 6, wherein the phosphorus source used comprises at least one of the compounds selected from the group consisting of basic slags, bone flour, phosphoric acid, phosphated rock, phosphatic concentrates, single super phosphate, triple super phosphate and super phosphoric acid.

10. The process, as set forth in claim 6, wherein the potassium source used comprises at least one of the compounds selected from the group consisting of potassium chloride, potassium carbonate, double potassium-magnesium sulphate and potassium sulphate.

11. The process, as set forth in claim 6, wherein the nitrogen, phosphorus, potassium, calcium, magnesium, sulphur sources and other micronutrients used comprise at least one member of the group consisting of the compounds selected from ammoniated super phosphate, ammonium nitro-phosphate, ammonium sulphonitrate, cottonseed hull ashes, diammonium phosphate, monoammonium phosphate, nitro-phosphate, potassium and sodium nitrate, wood ashes, basic high-furnace slags, dolomite, plaster, kieserite, lime, sulphocalcic solution, magnesium sulphate and sulphur.

12. The process, as set forth in claim 6, wherein the calcium source used comprises at least one of the compounds selected from the group consisting of high-furnace slags, calcitic lime, dolomitic lime, plaster, calcium oxide (quicklime), calcium hydroxide, calcium sulphate, marble, calcium cyanamide, calcium nitrate, phosphatic rock, single super phosphate and triple super phosphate.

13. The process, as set forth in claim 6, wherein the magnesium source used comprises at least one of the compounds selected from dolomitic lime, magnesium sulphate, calcined kieserite, magnesia, double potassium-magnesium sulphate.

14. The process, as set forth in claim 6, wherein the sulphur source used comprises at least one of the compounds selected from the group consisting of ammonium sulphate, iron sulphate, copper sulphate, magnesium sulphate (bitter salt), phosphoplaster, manganese sulphate, single super phosphate, double potassium-magnesium sulphate, elementary sulphur, sulphur dioxide, triple super phosphate and zinc sulphate.

15. The process, as set forth in claim 6, wherein the boron source used comprises at least one of the compounds selected from the group consisting of boron frits, borax, boric acid, sodium pentaborate, sodium tetraborate and Solubor;

16. The process, as set forth in claim 6, wherein the copper source used comprises at least one of the compounds selected from the group consisting of basic copper sulphate, copper ammonium phosphate, copper chelates (Na₂CuHEDTA), copper chloride, copper frits, REAX copper, TDHIS copper, Silviplex copper, copper sulphate monohydrate, copper sulphate pentahydrate, copper oxide, cuprous oxide and Rayplex copper;

17. The process, as set forth in claim 6, wherein the iron source used comprises at least one of the compounds selected from the group consisting of iron ammonium phosphate, iron ammonium polyphosphate, iron frits, ferric sulphate, ferrous sulphate, iron chelates (NaFeEDTA or FeHEDTA), Reax iron, THIS iron, Silviplex iron and Rayplex iron.

18. The process, as set forth in claim 6, wherein the manganese source used comprises at least one of the compounds selected from the group consisting of manganese chelates (MnEDTA), REAX manganese (MnMPP), TDHIS manganese (MnPP), Silviplex manganese (MnMPPP), manganese sulphate, manganese frits, manganese oxide and Rayplex manganese (MnPF).

19. The process, as set forth in claim 6, wherein the molybdenum source used comprises at least one of the compounds selected from the group consisting of sodium molybdate, molybdenum trioxide and ammonium molybdate;

20. The process, as set forth in claim 6, wherein the zinc source used comprises at least one of the compounds selected from the group consisting of zinc carbonate, zinc chelates (Na₂ZnEDTA or NaZnHEDTA), zinc oxide, REAX zinc (ZnMPP), TDHIS zinc (ZnPP), Silviplex zinc (ZnMPPP), zinc sulphate and Rayplex zinc (ZnPF);

21. The process, as set forth in claim 6, which comprises adding ammonium carbonate obtained from the reaction between the commercial ammonia and carbonic gas originating from the alcoholic fermentation of fermentable sugary compounds.

22. The process, as set forth in claim 6, wherein the drying/mixing of the OMF components is carried out in the sequence: mixing the boiler ashes with the moist cake; dewatering and drying the ashes and cake mixture; adding the macro- and micronutrients to the concentrated vinasse; mixing the cake and dry ashes with the concentrated vinasse containing the macro- and micronutrients; and, drying the mixture.

23. The process, as set forth in claim 22, wherein drying of the cake and boiler ash mixture and of the final mixture is effected in a single stage or in several stages, with the drying gases flowing in a parallel-flow or cross-flow.

24. The process, as set forth in claim 1, which comprises concentrating the vinasse through serial evaporators operated in cascade under vacuum.

25. The process, as set forth in claim 21, wherein the steam used in a first vinasse evaporative effect is an exhausted steam or vegetal vapor originating from a pre-evaporator or second and third evaporative effects applied to the sugar cane juice.

26. The process, as set forth in claim 21, which comprises carrying out the first vinasse evaporative effect with effluent gases from the drying of the cake and vinasse mixture.

27. The process, as set forth in claim 1, wherein the gases used for drying the cake and vinasse mixture, optionally containing ashes and fertilizers mixtures, consist of the gas coming from the sugar cane bagasse and/or fine straw burning, and/or gas effluent from the boiler chimney.

28. The process of claim 2, wherein the vinasse is concentrated to 65% (p/p) of dry matter.

29. The process according to claim 3, which comprises achieving a moisture level between 2% and 10%.

30. The process as set forth in claim 21, wherein the sugary compounds are selected from the group consisting of sugar cane, beet corn, and sorghum.

31. The method of claim 23, wherein the drying is carried out in dryers of the fluidized bed type, vibro-fluidized dryer spouted bed dryer, rotary drum dryer, or in a turbo dryer.

32. The method of claim 24, which comprises carrying out the drying in falling-film or turbulent mist evaporators, using steam as a heating source.
